(19) United States
(12) Patent Application Publication
(10) Pub. No.: US 2006/0042922 A1
(43) Pub. Date: Mar. 2, 2006

(54) Trip component locking assembly and electrical switching apparatus employing the same

(76) Inventors: Thomas L. Aber, Verona, PA (US); Phillip L. Ulerich, Longwood, FL (US); Joseph B. Humbert, Monaca, PA (US); Mark A. McAfee, Georgetown, PA (US)

Correspondence Address: Martin J. Moran;Eaton Electrical, Inc., Technology & Quality Center, 170 Industry Drive, RIDC Park West, Pittsburgh, PA, 15275-1032, US

(21) Appl. No.: 10/925,795

(22) Filed: Aug. 25, 2004

(51) Int. Cl. H01H 3/20

(52) U.S. Cl. 200/430

(57) ABSTRACT

A locking assembly is for the trip bar of a circuit breaker. A pivotal trip lever is coupled to the trip bar, in order to move therewith. The locking assembly includes: a locking mechanism, such as a commercially available key lock, with a pivotal element; a mounting plate, which receives the key lock and secures it to the circuit breaker; an extension member coupled to the pivotal element; and a flexible linkage interconnecting the pivotal trip lever and the extension member. The key lock has locked and unlocked positions corresponding to the trip bar of the circuit breaker being locked and unlocked, respectively. The flexible linkage is interchangeable or universally employable with a variety of commercially available locks, in order to lock the trip component of a wide variety of electrical switching apparatus.

### BACKGROUND OF THE INVENTION

1. Field of the Invention

The present invention relates generally to electrical switching apparatus and, more particularly, to a locking assembly for locking the tripping component of a circuit breaker.

2. Background Information

For safety, electrical switching apparatus, such as circuit breakers, may be de-energized before performing an operation (e.g., maintenance; test; reconfiguration) thereon. Damage to electrical equipment, severe personal injury and even death can result from contact with electrical equipment when it is energized. It is, therefore, often desirable to maintain the breaker in the open and discharged condition during such operations. One way of accomplishing this is to lock the tripping component of the circuit breaker in the tripped position, thereby preventing the separable contacts of the breaker from closing.

Known prior art circuit breakers employ a variety of locking assemblies in order to prevent the circuit breaker from closing when maintenance is being performed. One such device involves an interlock assembly which employs a commercially available lock, such as a key lock (e.g., without limitation, key locks respectively sold under the trademarks CASTELL®, RONIS® and KIRK®), which is coupled to the tripping component (e.g., trip bar) of the circuit breaker in order that the configuration of the circuit breaker can be controlled (e.g., locked) from outside the breaker.

FIGS. 1-3 illustrate representative circuit breaker interlocks employing commercially available CASTELL®, RONIS® and KIRK® key interlocks, respectively. As shown in FIG. 1, a CASTELL® key lock 2 is employed with a custom mounting kit 4 in order to provide a connection between the lock 2 and the trip bar 6 of the circuit breaker 8. The mounting kit 4 includes a mounting plate 10 located just beneath the front cover (removed in FIG. 1 in order to show internal circuit breaker structures) of the circuit breaker 8. The mounting plate 10 is structured to receive the particular type of interlock being employed (e.g., the CASTELL® key lock 2 of FIG. 1). The circuit breaker trip bar 6 includes a trip lever 12 which rotates therewith. A rigid interlock bracket 14 is coupled at one end to the trip lever 12 and at the other end to a rotating extension 16 attached to the back of the lock 2. The rotating extension 16 rotates when a key 18 is inserted into the lock 2 and rotated, thereby moving the rigid interlock bracket 14 which moves the trip lever 12 and holds the circuit breaker 8 open. The circuit breaker 8 remains open or tripped, with the trip bar 6 being locked, until the key 18 is rotated back to the initial, unlocked position.

FIGS. 2 and 3 show circuit breaker locking assemblies employing two additional types of commercially available locks (e.g., RONIS® key interlock 20 of FIG. 2; KIRK® key interlock 22 of FIG. 3).

Each type of lock employs a different key 18 (FIG. 1), 18′ (FIG. 2), 18″ (FIG. 3) and has its own unique shape and configuration. It is, therefore, necessary to provide different custom mounting kits 4 (FIG. 1), 4′ (FIG. 2) and 4″ (FIG. 3) each having different rigid interlock brackets 14 (FIG. 1), 24 (FIG. 2) and 26 (FIG. 3) which are tailored to the respective locks 2, 20 and 22, in order for the assembly to operate properly and lock the trip bar 6 of the circuit breaker 8. Such rigid interlock brackets 14, 24, 26 are not interchangeable and they include a plurality of complex bends, holes and slots which are time consuming and cost intensive to make. Moreover, the rigid nature of the interlock brackets (e.g., 14, 24, 26) limits their application to one specific circuit breaker, interlock combination.

It is, therefore, desirable to provide an economical locking assembly which may be employed in a variety of electrical switchgear applications.

There is, therefore, room for improvement in locking assemblies for the trip components of electrical switching apparatus and in electrical switching apparatus employing locking assemblies.

### SUMMARY OF THE INVENTION

These needs and others are satisfied by the present invention, which is directed to a locking assembly for the trip component of an electrical switching apparatus, such as the trip bar of a circuit breaker. The locking assembly includes a flexible linkage which is economical to make and which is interchangeable for use with a variety of electrical switching apparatus employing any known or suitable commercially available lock.

As one aspect of the invention, a locking assembly is for an electrical switching apparatus including separable contacts and an operating mechanism for opening and closing the separable contacts. The operating mechanism includes a trip component operable between first and second positions corresponding to the separable contacts being tripped open and closable, respectively, and a pivotal trip lever coupled to the trip component in order to move therewith. The locking assembly comprises: a locking mechanism including a pivotal element; a mounting plate structured to receive the locking mechanism and secure it to the electrical switching apparatus; an extension member coupled to the pivotal element of the locking mechanism and adapted to move therewith; and a flexible linkage structured to interconnect the pivotal trip lever and the extension member.

As another aspect of the invention, the pivotal trip lever may be included as a component of the locking assembly which is structured to be subsequently coupled to the trip component of the electrical switching apparatus in order to move therewith.

The locking mechanism may have locked and unlocked positions corresponding to the first and second positions, respectively, of the trip component wherein the extension member is adapted to move with the pivotal element of the locking mechanism thereby moving the flexible linkage which is structured to pivot and lock the pivotal trip lever and the trip component to which the pivotal trip lever is structured to be coupled, in the first position when the pivotal element of the locking mechanism is disposed in the locked position. The trip component and the pivotal trip lever may be spring-loaded, in order that it is biased, for example, toward the second position. The extension member may be adapted to move with the pivotal element of the locking mechanism thereby moving the flexible linkage which is structured to permit the pivotal trip lever and the trip component to which it is structured to be coupled, to unlock and pivot toward the second position when the pivotal element of the locking mechanism is pivoted from the locked position to the unlocked position.

The flexible linkage may be a cable including first and second ends which are coupled to the pivotal trip lever and the extension member, respectively, by fasteners. The pivotal trip lever and the extension member may include first and second openings, respectively, wherein the first and second ends of the cable include first and second eyelets, respectively, and the first end of the cable is secured to the pivotal trip lever by one of the fasteners inserted through the first eyelet into the first opening of the pivotal trip lever and the second end of the cable is secured to the extension member by another one of the fasteners inserted through the second eyelet into the second opening of the extension member.

As another aspect of the invention, an electrical switching apparatus comprises: separable contacts; an operating mechanism for opening and closing the separable contacts, the operating mechanism including a trip component operable between first and second positions corresponding to the separable contacts being tripped open and closable, respectively, a pivotal trip lever coupled to the trip component in order to move therewith; and a locking assembly comprising: a locking mechanism including a pivotal element, a mounting plate for receiving the locking mechanism and securing it to the electrical switching apparatus, an extension member coupled to the pivotal element of the locking mechanism in order to move therewith, and a flexible linkage interconnecting the pivotal trip lever and the extension member.

The electrical switching apparatus may be a circuit breaker wherein the trip component of the circuit breaker is a trip bar. The locking mechanism may be a commercially available key lock, wherein the pivotal element of the key lock receives a key and pivots when the key is inserted and rotated.

### BRIEF DESCRIPTION OF THE DRAWINGS

A full understanding of the invention can be gained from the following description of the preferred embodiments when read in conjunction with the accompanying drawings in which:

FIG. 1 is an isometric view of a locking assembly employing a CASTELL® key lock in order to lock the trip bar of a circuit breaker, with the front cover of the circuit breaker removed to show internal structures.

FIG. 2 is an isometric view of another locking assembly employing a RONIS® key lock in order to lock the trip bar of the circuit breaker, with the front cover of the circuit breaker removed to show internal structures.

FIG. 3 is an isometric view of another locking assembly employing a KIRK® key lock in order to lock the trip bar of the circuit breaker, with the front cover of the circuit breaker removed to show internal structures.

FIG. 4 is an isometric view of the right side of a circuit breaker, shown employing a locking assembly in accordance with the present invention, with portions of the circuit breaker removed to show internal structures.

### DESCRIPTION OF THE PREFERRED EMBODIMENTS

For purposes of illustration, the invention will be described as applied to the trip component of a circuit breaker in order to prevent closing of the breaker separable contacts during the performing of an operation (e.g., maintenance; test; reconfiguration) thereon, although it will become apparent that it could also be applied to other types of electrical switching apparatus (e.g., without limitation, circuit switching devices and other circuit interrupters such as contactors, motor starters, motor controllers and other load controllers) including a trip mechanism wherein locking of such mechanism is desirable.

Directional phrases used herein, such as, for example, left, right, front, back, clockwise, counterclockwise and derivatives thereof, relate to the orientation of the elements shown in the drawings and are not limiting upon the claims unless expressly recited therein.

As employed herein, the term “fastener” refers to any suitable connecting or tightening mechanism expressly including, but not limited to, screws, bolts and the combinations of bolts and nuts (e.g., without limitation, lock nuts) and bolts, washers and nuts.

As employed herein, the statement that two or more parts are “coupled” together shall mean that the parts are joined together either directly or joined through one or more intermediate parts.

As employed herein, the term “linkage” refers to any known or suitable mechanism for interconnecting one component of a structure or assembly to another component thereof, in order to provide mechanical communication therebetween. For example, as discussed herein, the exemplary linkage is a flexible cable. However, it will be appreciated that any suitable linkage (e.g., without limitation, a wire; a chain; a spring; a number of interconnected links) could alternatively be employed.

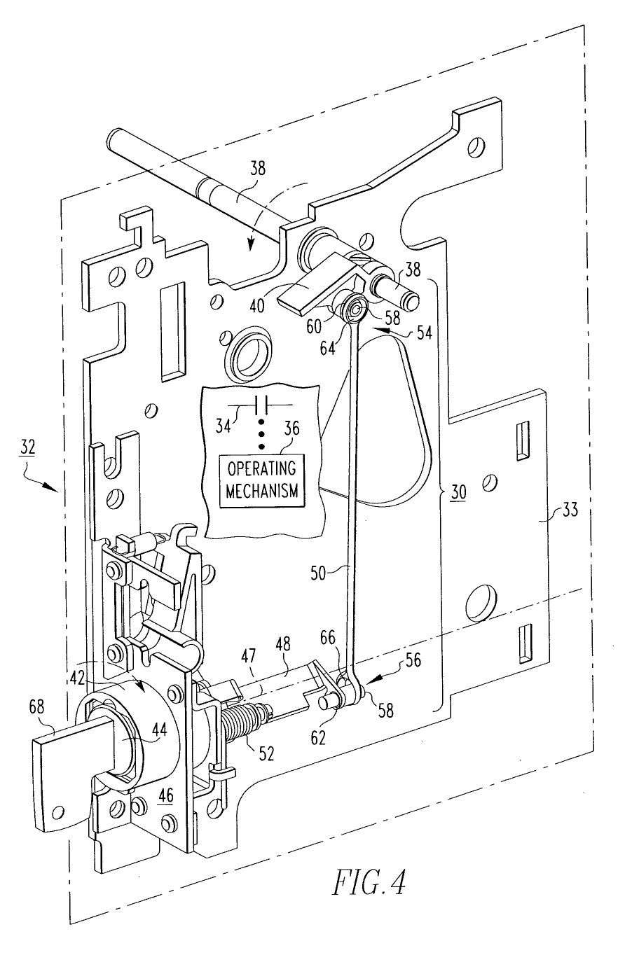

FIG. 4 shows a locking assembly 30 for an electrical switching apparatus such as the circuit breaker 32, shown. The circuit breaker 32 includes separable contacts 34 and an operating mechanism 36 for opening and closing the separable contacts 34. The operating mechanism 36 includes a trip component, such as the exemplary trip bar 38, which is operable between first and second positions corresponding to the separable contacts 34 being tripped opened and closable, respectively. A pivotal trip lever 40 is coupled to the trip bar 38 and is adapted to move therewith. It will be appreciated, as discussed in further detail herein, that the pivotal trip lever 40 may comprise an integral part of the circuit breaker 32 or trip bar 38 or alternatively, may be a customized, separate component of the exemplary locking assembly 30 which is subsequently coupled to trip bar 38 of the circuit breaker 32 in order to move therewith.

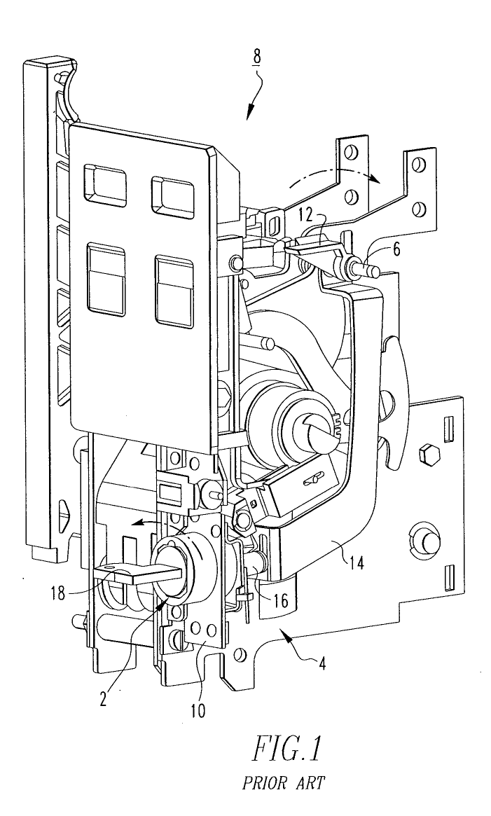

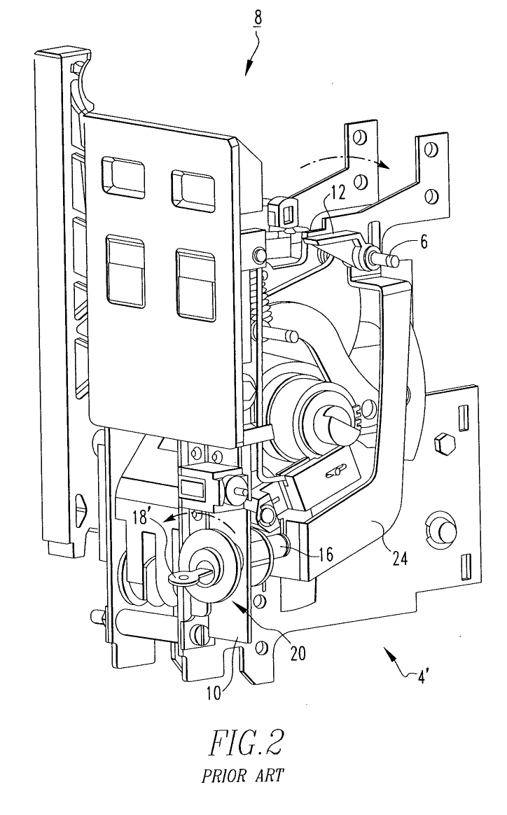

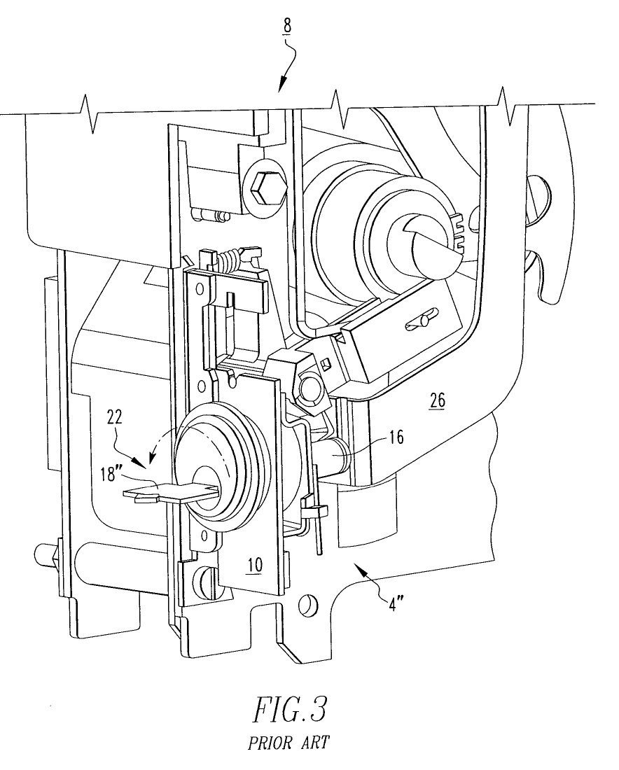

As shown, the exemplary locking mechanism 42 includes a pivotal element 44, a mounting plate 46 structured to receive the locking mechanism 42 and secure it to the circuit breaker 32, an extension number 48 coupled to the pivotal element 44 and adapted to move therewith, and a flexible linkage 50 structured to interconnect the pivotal trip lever 40 and the extension member 48. The mounting plate 46 of the exemplary locking assembly 30 secures the locking mechanism 42 to one of the sides (e.g., 33) of the circuit breaker 32 just beneath the front cover (not shown in FIG. 4) of the circuit breaker 32. The exemplary mounting plate 46 is structured to receive any known or suitable commercially available lock (e.g., CASTELL® key interlock 2; RONIS® key interlock 20; and KIRK® key interlock 22), in order that the lock will protrude through the circuit breaker front cover (not shown) and be operable from outside of the circuit breaker 32. The locking mechanism 42 has locked and unlocked positions corresponding to the first and second positions, respectively, of the exemplary trip bar 38. For example, the exemplary pivotal element 44, shown in FIG. 4, may rotate clockwise from the unlocked position, shown, to a locked position (not shown in FIG. 4, but see, e.g., FIGS. 1-3). The extension member 48 of the locking assembly 30 moves with such pivotal element 44 hereby moving the pivotal trip lever 40 interconnected by way of the flexible linkage 50, thereto. The exemplary flexible linkage is a cable 50. However, it will be appreciated that any known or suitable alternative flexible linkage (e.g., without limitation, a chain; a series of interconnected links; a wire; a spring) (not shown) could alternatively be employed to interconnect the pivotal trip lever 40 and the extension member 48.

Like the trip bar 6 and trip lever 12 of the locking assemblies discussed previously in connection with FIGS. 1-3, the exemplary trip bar 38 or pivotal trip lever 40 include a spring (not shown), such as a torsional spring, which is disposed between the trip bar 38 or pivotal trip lever 40 and the circuit breaker 32. The spring is adapted to bias these trip components 38, 40 in the clockwise direction toward the second position wherein the circuit breaker 32 separable contacts 34 are closable. The aforementioned rigid interlock brackets 14, 24, 26 (FIGS. 1-3, respectively) are structured to move up and down with respect to the circuit breaker 8 (FIGS. 1-3), in order to engage and pull the trip lever 12 (FIGS. 1-3) downward and lock it in the tripped open position when the key 18, 18′ 18″ (FIGS. 1-3, respectively) is rotated clockwise to the locked position, shown. It will be appreciated that in order to operate properly, such rigid brackets must be precisely customized for each particular application. This is a cost intensive endeavor.

Conversely, the exemplary flexible cable 50, as will be discussed in further detail hereinbelow, is adapted to couple at one end to a first opening 60 provided in the pivotal trip lever 40 and at the other end, to the extension member 48 of the locking mechanism pivotal element 44, in order to pivot the pivotal trip lever 40 counterclockwise against the aforementioned spring bias and lock it in the tripped open position when the locking mechanism 42 is locked (not shown in FIG. 4, but see, e.g., FIGS. 1-3). Accordingly, the exemplary flexible cable 50 is capable of performing the same trip component locking function as the rigid interlock brackets 14, 24, 26 discussed previously in connection with FIGS. 1-3, respectively. However, it is also able to accommodate variations (e.g., size variations; position variations) between the different lock types (e.g., 2, 20, 22) without requiring the manufacture of a separate rigid interlock bracket for each lock type.

As previously discussed, the pivotal trip lever 40 may be a separate component of the exemplary locking assembly 30, which is subsequently coupled to the trip bar 38 of the circuit breaker 32. In such a configuration, the pivotal trip lever 40 is preferably provided with the first opening 60 for attachment of the exemplary cable 50. However, it will be appreciated that, alternatively, the pivotal trip lever 40 may comprise an existing component of the circuit breaker 32, which may be subsequently modified (e.g., drilled), in order to create the desired first opening 60 therein. It will also be appreciated that new circuit breakers 32 may be made to include such first opening 60 in the pivotal trip lever 40. The first end 54 of the exemplary cable 50 includes a first eyelet 64 and is secured by a fastener 58, such as a screw or other suitable fastener (not shown), inserted through the first eyelet 64 into the first opening 60 of the pivotal trip lever 40. The second end 56 of the cable 50 includes a second eyelet 66 and is coupled to a second opening 62 provided in the extension member 48. Specifically, like the first end 54 of the exemplary cable 50, a fastener 58 is inserted through the second eyelet 66 of the second end 56 and is subsequently threaded or otherwise suitably secured within second opening 62 of the extension member 48. It will be appreciated that, while the exemplary extension member 48 is preferably a universally applicable component, useable with a wide variety of locks (e.g., 2, 20, 22), it may be necessary to customize (e.g., shorten; lengthen; bend) such member, in order that it functions properly with the particular type of lock being employed.

In operation, as previously discussed, the exemplary locking mechanism 42 rotates clockwise (to lock) and counterclockwise (to unlock) between locked and unlocked (FIG. 4) positions corresponding to the first and second positions, respectively, of the exemplary trip bar 38. The exemplary locking mechanism is a key lock 42 which receives a key 68 that, upon being inserted into the pivotal element 44 and turned, provides such rotation. When the key lock 42 is in the unlocked position, as shown in FIG. 4, the trip bar 38 of the circuit breaker 32 is unlocked thereby permitting the separable contacts 34 of the circuit breaker 32 to be closed, in order to energize the circuit breaker 32. Conversely, when the exemplary key 68 is turned clockwise to the locked position (not shown, but see e.g., FIGS. 1-3), the pivotal element 44 of the locking mechanism 42 also rotates clockwise thereby permitting the exemplary cable 50 to move upward which allows the pivotal trip lever 40 and the trip bar 38 coupled thereto, clockwise to the first position. When locked in such first position (not shown, but see e.g., FIGS. 1-3), the trip bar 38 is locked, thereby preventing charging and discharging of the circuit breaker 32. In this manner, the circuit breaker 32 may be locked while performing an operation (e.g., without limitation, maintenance; test; reconfiguration) thereon, in order to resist undesirable or inadvertent energizing of the circuit breaker 32 and possible human injury or damage to electrical equipment as a result thereof.

As shown in FIG. 4, the second opening 62 of the exemplary extension member 48 is offset or eccentric from the centerline 47 of the extension member 48, thereby enabling the cable 50 to be pulled downward when the pivotal element 44 is rotated clockwise. This in turn pulls the pivotal trip lever 40 downward, rotating it and trip bar 38 to which it is secured, counterclockwise against the spring bias. The exemplary extension member 48 further includes a second spring, such as the exemplary torsional spring 52, shown. The torsional spring 52 biases the extension member 48 in order to facilitate movement of the pivotal element 44, the cable 50 coupled thereto and thus the pivotal trip lever 40 and trip bar 38 interconnected therewith. It will, however, be appreciated that the extension member 48 could be configured differently than as it is shown and described herein. For example, the second opening 62 does not have to be offset from centerline 47. It could, alternatively, be disposed on the centerline 47 (not shown). In such a configuration, if the cable 50 is sufficiently secured (e.g., tightened) to the extension, rotation of the extension member 48 would rotate the cable 50 secured thereto sufficiently, in order to pull downward on the pivotal trip lever 40. It will also be appreciated that the extension member 48 need not be spring-loaded and that one or more of the springs (e.g., 52) described herein could be configured to bias the particular component to which they are coupled, in the opposite direction to that described herein. In such configuration, the locked and unlocked positions of the locking mechanism 42 would likely be reversed from those described herein.

It will, as previously discussed, be appreciated that the locking assembly 30 of the present invention could be employed in a variety of applications other than the example described and illustrated herein. One example of another circuit breaker application is with coded key interlocks, which are commonly used in security systems where it is important that only certain circuit breakers or combinations of circuit breakers are switched ON at the same time. In such a system, each coded key typically controls a specific group of circuit breakers. One or more of the exemplary locking assemblies could be employed within such a coded security system. As discussed hereinbefore, the invention is also readily applicable for use with a variety of electrical apparatus other than circuit breakers. It will also be appreciated that the locking assembly 30 may be arranged in any suitable configuration other than the one illustrated and described herein.

In summary, the exemplary locking assembly 30 provides a compliant flexible linkage 50 which is useable with a variety of commercially available locks (e.g., without limitation, 2, 20, 22), in order to convert rotational motion of the lock into a linear motion which in turn engages the trip component (e.g., 38, 40) of the circuit breaker 32 and locks it from a position outside of the circuit breaker 32 (e.g., from the front, right side 33 of the circuit breaker 32, of FIG. 4). Accordingly, the locking assembly of the present invention provides an economical safety device which is readily employable to engage and lock the trip components of a wide array of different electrical switchgear.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

1. A locking assembly for an electrical switching apparatus including separable contacts and an operating mechanism for opening and closing said separable contacts, said operating mechanism including a trip component operable between first and second positions corresponding to said separable contacts being tripped open and closable, respectively, and a pivotal trip lever coupled to said trip component in order to move therewith, said locking assembly comprising:
a locking mechanism including a pivotal element;
a mounting plate structured to receive said locking mechanism and secure it to said electrical switching apparatus;
an extension member coupled to said pivotal element of said locking mechanism and adapted to move therewith; and
a single-piece flexible linkage structured to interconnect said pivotal trip lever and said extension member, said single-piece flexible linkage being taut with respect to said pivotal trip lever and said extension member when said trip component is disposed in said first position.

2. A locking assembly for an electrical switching apparatus including separable contacts and an operating mechanism for opening and closing said separable contacts, said operating mechanism including a trip component operable between first and second positions corresponding to said separable contacts being tripped open and closable, respectively, said locking assembly comprising:
a locking mechanism including a pivotal element;
a mounting plate structured to receive said locking mechanism and secure it to said electrical switching apparatus;
an extension member coupled to said pivotal element of said locking mechanism and adapted to move therewith;
a pivotal trip lever structured to couple to said trip component of said electrical switching apparatus in order to move therewith; and
a single-piece flexible linkage interconnecting said pivotal trip lever and said extension member.

3. The locking assembly of claim 2 wherein said locking mechanism has locked and unlocked positions corresponding to said first and second positions, respectively, of said trip component.

4. The locking assembly of claim 3 wherein said extension member is adapted to move with said pivotal element of said locking mechanism thereby moving said single-piece flexible linkage which pivots and locks said pivotal trip lever in said first position when said pivotal element of said locking mechanism is disposed in said locked position.

5. The locking assembly of claim 4 wherein said trip component and said pivotal trip lever are spring-loaded; wherein said spring-loaded trip component and pivotal trip lever are biased toward said second position in which said separable contacts are closable; and wherein said extension member is adapted to move with said pivotal element of said locking mechanism thereby moving said single-piece flexible linkage which unlocks said pivotal trip lever permitting it to pivot toward said second position when said pivotal element of said locking mechanism is pivoted from said locked position to said unlocked position.

6. The locking assembly of claim 4 wherein said extension member includes a spring adapted to facilitate movement of said single-piece flexible linkage and thus said pivotal trip lever and said trip component to which said trip lever is adapted to be coupled, when said pivotal element of said locking mechanism is pivoted.

7. The locking assembly of claim 2 wherein said single-piece flexible linkage is a cable including first and second ends which are coupled to said pivotal trip lever and said extension member, respectively, by fasteners, said cable being taut with respect to said pivotal trip lever and said extension member when said trip component is disposed in said first position.

8. The locking assembly of claim 7 wherein said pivotal trip lever includes a first opening; wherein said extension member includes a second opening; wherein the first and second ends of said cable include first and second eyelets, respectively; and wherein the first end of said cable is structured to be secured to said pivotal trip lever by one of said fasteners inserted through said first eyelet into the first opening of said pivotal trip lever and the second end of said cable is structured to be secured to said extension member by another one of said fasteners inserted through said second eyelet into the second opening of said extension member.

9. The locking assembly of claim 8 wherein said extension member includes a centerline; and wherein said second opening of said extension member is offset from said centerline.

10. The locking assembly of claim 2 wherein said locking mechanism is a key lock; and wherein said pivotal element of said key lock is adapted to receive a key and to be pivoted upon insertion and rotation of said key.

11. the locking assembly of claim 2 wherein said electrical switching apparatus is a circuit breaker; and wherein said trip component of said circuit breaker is a trip bar.

12. an electrical switching apparatus comprising:
separable contacts;
an operating mechanism for opening and closing said separable contacts, said operating mechanism including a trip component operable between first and second positions corresponding to said separable contacts being tripped open and closable, respectively;
a pivotal trip lever coupled to said trip component in order to move therewith; and
a locking assembly comprising:
a locking mechanism including a pivotal element,
a mounting plate for receiving said locking mechanism and securing it to said electrical switching apparatus,
an extension member coupled to said pivotal element of said locking mechanism in order to move therewith, and
a single-piece flexible linkage interconnecting said pivotal trip lever and said extension member.

13. The electrical switching apparatus of claim 12 wherein said locking mechanism has locked and unlocked positions corresponding to said first and second positions, respectively, of said trip component.

14. The electrical switching apparatus of claim 13 wherein said extension member moves with said pivotal element of said locking mechanism thereby moving said single-piece flexible linkage which pivots and locks said pivotal trip lever and said trip component coupled thereto in said first position when said pivotal element of said locking mechanism is disposed in said locked position.

15. The electrical switching apparatus of claim 14 wherein said trip component and said pivotal trip lever are spring-loaded; wherein said spring-loaded trip component and pivotal trip lever are biased toward said second position in which said separable contacts are closable; and wherein said extension member moves with said pivotal element of said locking mechanism thereby moving said single-piece flexible linkage which unlocks said pivotal trip lever permitting it and said trip component to which it is coupled, to pivot toward said second position when said pivotal element of said locking mechanism is pivoted from said locked position to said unlocked position.

16. The electrical switching apparatus of claim 14 wherein said extension member includes a spring; and wherein said spring biases said extension member in order to facilitate movement of said single-piece flexible linkage and thus said pivotal trip lever and said trip component coupled thereto, when said pivotal element of said locking mechanism is pivoted.

17. The electrical switching apparatus of claim 12 wherein said single-piece flexible linkage is a cable including first and second ends which are coupled to said pivotal trip lever and said extension member, respectively, by fasteners, said cable being taut with respect to said pivotal trip lever and said extension member when said trip component is disposed in said first position.

18. The electrical switching apparatus of claim 17 wherein said pivotal trip lever includes a first opening; wherein said extension member includes a second opening; wherein the first and second ends of said cable include first and second eyelets, respectively; and wherein the first end of said cable is secured to said pivotal trip lever by one of said fasteners inserted through said first eyelet into the first opening of said pivotal trip lever and the second end of said cable is secured to said extension member by another one of said fasteners inserted through said second eyelet into the second opening of said extension member.

19. the electrical switching apparatus of claim 18 wherein said extension member includes a centerline; and wherein said second opening of said extension member is offset from said centerline.

20. The electrical switching apparatus of claim 12 wherein said locking mechanism is a key lock; and wherein said pivotal element of said key lock receives a key and pivots when said key is inserted and rotated.

21. the electrical switching apparatus of claim 12 wherein said electrical switching apparatus is a circuit breaker; and wherein said trip component of said circuit breaker is a trip bar.
